(19) United States
(12) Patent Application Publication
(10) Pub. No.: US 2014/0370960 A1
(43) Pub. Date: Dec. 18, 2014

(54) GAME ACTIVATING TOKEN

(71) Applicant: Gateway Gaming, LLC, Piedmont, SC (US)

(72) Inventors: Bobby MOSLEY, Piedmont, SC (US); Timothy CALDWELL, Piedmont, SC (US)

(21) Appl. No.: 13/917,604

(22) Filed: Jun. 13, 2013

(51) Int. Cl. G07F 17/32

(52) U.S. Cl. CPC G07F 17/3248
USPC 463/20

(57) ABSTRACT

System and methods for utilizing a game activating token are provided. The game activating token is received in a slot of a token reader and through a passageway to a reading region. An identifier transmitted by the game activating token is read while the token is in the reading region, and the identifier can be communicated to a gaming machine for activating a game.

### BACKGROUND

Gaming machines have developed from mechanically-operated machines, such as slot machines, to video-based gaming machines that operate software to provide similar types of games. The games can be activated by a potential player making payment. As the game is played, credits may be debited and added by the machine. If the user desires to terminate play of a game or a gaming session, the user may be able to cash out to receive a payment or payment voucher for any value remaining or earned.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to a game activating token in the form of a recognizable coin to facilitate operating video-based gaming devices that may require coin insertion to activate games. In one example, a system for receiving a game activating token is provided that includes a token reader comprising an identifier reading component disposed within a reading region of a token reader, and a slot for receiving a game activating token having an associated identifier. The identifier reading component receives the associated identifier from the game activating token based at least in part on insertion of the game activating token in the slot. The system further includes a gaming machine for receiving the associated identifier of the game activating token from the token reader.

In addition, in an example, a method for providing an identifier of a game activating token is provided that includes receiving the game activating token in a slot and through a passageway to a reading region, reading an identifier transmitted by the game activating token in the reading region, and communicating the identifier to a gaming machine for activating a game.

In yet another example, a system for activating a game is provided that includes a token reader for reading a radio frequency identifier (RFID) tag of a game activating token based at least on insertion of the game activating token into a slot of the token reader, an account information server for obtaining account information associated with the game activating token based at least in part on the RFID, wherein the account information includes a value associated with the game activating token, and a gaming machine for activating a game, wherein the gaming machine receives the value associated with the game activating token and initializes a game with a credit value based at least in part on the value associated with the game activating token.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements.

FIGS. 1A-1C illustrate multiple views of an example token reader in accordance with aspects described herein.

FIGS. 2A-2B illustrate multiple views of an example token reader and box in accordance with aspects described herein.

FIGS. 3A-3B illustrate multiple views of an example token reader with multiple boxes in accordance with aspects described herein.

FIGS. 4A-4B illustrate multiple views of an example token reader with an open return box in accordance with aspects described herein.

FIG. 5 is an aspect of an example system for reading token identifiers and obtaining related value information.

FIG. 6 is an aspect of an example system for activating a game based on value related to a read token identifier.

FIG. 7 is an aspect of an example methodology for communicating a read token identifier to a gaming machine.

FIG. 8 is an aspect of an example methodology for activating a game based on a value associated with a read token identifier.

FIG. 9 is an aspect of an example system in accordance with aspects described herein.

FIG. 10 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to a game-activating token and a token reader for obtaining information from the game-activating token. For example, the token can include a mechanism for substantially uniquely identifying the token to the token reader, such as a token identifier (e.g., an RFID that can be read by an RFID reader in the token reader). This can facilitate associating the token with a user account for managing credits of the user account for playing a game. For example, the token reader can be communicatively coupled to a video-based gaming device for communicating an identifier read from the token, or information associated therewith, to the gaming device for activating and/or operating the game based on user information associated with the token identifier and/or other information. The token reader, for example, can define a slot for receiving the token and a reading region within which an identifier of the token can be obtained. The token reader can read the identifier when the token is in the reading region, and can communicate the identifier or related information to the video-based gaming device. In an example, the video-based gaming device can use the identifier to retrieve related information (e.g., account information).

As used in this application, the terms “component,” “module,” “system,” “device” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

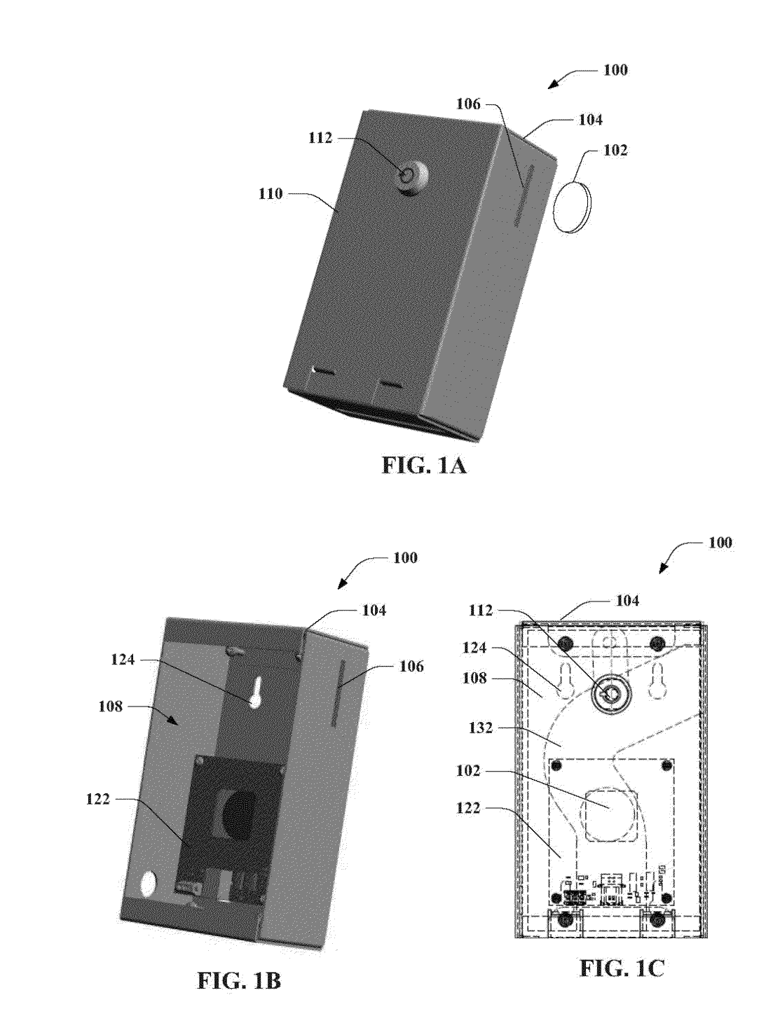

FIGS. 1A-1C illustrate multiple views of a token reader system 100 for receiving a token 102 and reading one or more identifiers of the token 102. The token reader system 100 includes a token reader 104 adapted to receive a token 102 for processing information associated therewith. Token reader 104, for example, can be used in conjunction with a video-based gaming machine, as described further herein, for activation thereof based on receiving token 102. In this regard, for example, the video-based gaming machine can be coin-operated, where the token 102 can be of a coin shape for inserting into a slot 106 on the token reader 104. Thus, for example, insertion of the token 102 in token reader 104 can cause activation or other operation of the video-based gaming machine. Token reader 104 can comprise the slot 106 for receiving the token 102 into a cavity 108 of the token reader 104. The cavity 108 is also referred to herein as a reading region 108 of the token reader 104.

FIG. 1A additionally illustrates a cover plate 110 to enclose the reading region 108 of the token reader 104, and a lock 112 for locking the cover plate 110. In this regard, in one example, when the token 102 is inserted into slot 106, it may be irretrievably inserted such that retrieval can only occur by physical removal from the reading region 108 or other cavity. For example, removal of the token 102 can occur by unlocking lock 112 and/or removing cover plate 110 from the token reader 104 to obtain the token 102 from the reading region 108 or other cavity. Moreover, though the slot 106 is shown on the side of the token reader, it is to be appreciated that the slot 106 can be disposed at the top of the token reader 104, another side, a front portion, a back portion, etc. so long as the slot 106 allows for receiving the token 102 into the reading region 108. In addition, cover plate 110 and/or lock 112 can be disposed on other areas of the token reader 104 to allow access to reading region 108 to obtain the token 102.

As shown in FIG. 1B, token reader 104 can comprise identifier reading component 122 for obtaining an identifier transmitted by the token 102 after the token 102 is inserted into slot 106. For example, as shown in FIG. 1C, token 102, upon insertion into slot 106, can traverse a defined passageway 132 in the reading region 108, which includes the identifier reading component 122. The identifier reading component 122 can obtain one or more identifiers of the token 102 when token 102 is within sufficient range such to receive the identifier therefrom (e.g., at a location within the reading region 108). In an example, the token 102 can comprise RFID electronics configured to transmit an RFID that is substantially unique to the token 102. In this example, identifier reading component 122 can comprise an RFID reader, or other identifier reading electronics, for obtaining the RFID of the token 102 when within range (e.g., within reading region 108).

The token reader 104 can be mounted to a video-based gaming machine (not shown) or other device by attaching mounting holes 124 to one or more posts on the machine or at a gaming station that houses the gaming machine, for example. In addition, the identifier reading component 122, or another component of token reader 104, can be communicatively coupled to the video-based gaming machine for communicating the identifier of tokens or related information thereto. In another example, identifier reading component 122 can be communicatively coupled to additional electronics of token reader 104 that can obtain account information related to the identifier of the token 102, and can communicate the account information directly or indirectly to the video-based gaming machine, etc. In yet another example, identifier reading component 122 can communicate the identifier to an account information server, which can access an account of the user associated with the identifier and accordingly activate the video-based gaming machine. In any case, the video-based gaming machine can access an account related to the token 102 identifier for determining a number of credits associated therewith, debiting credits, adding credits, etc., as described further herein. The video-based gaming machine can be activated based at least in part on receiving and/or processing the identifier of the token 102. In another example, token reader 104 can include an activating mechanism (not shown) that is triggered by insertion of token 102 into slot 106 that can cause activation of the video-based gaming machine, activation of the identifier reading component 122, and/or the like.

Moreover, in some examples, identifier reading component 122 can detect presence of the token 102 in reading region 108 over a period of time by periodically receiving the identifier thereof In this regard, identifier reading component 122 can detect removal of the token 102 from reading region 108 (e.g., by removing cover plate 110 to retrieve the token), and can take further action based on the detection. For example, token reader 104 can notify the video-based gaming machine of removal of token 102 or otherwise cause updating of credits associated with the corresponding account upon removal of token 102, in one example.

It is to be appreciated that at least an interior or exterior portion of token reader 104 can be constructed using materials that interfere with identifier transmission from the token 102 such that the token 102 identifier is not read outside of the token reader 104. For example, at least a portion of the reading region 108 can be at least partially constructed with a metal material, such as aluminum material (e.g., aluminum foil) and/or include metal (e.g., aluminum) walls, to block transmission of the identifier from the token 102 outside of the reading region 108, and to block transmission of identifiers of other tokens that are not within reading region 108. This can ensure only tokens 102 inserted into token reader 104 are read by the identifier reading component 122. Moreover, this construction can prevent unwanted readings by other nearby token readers 104, unauthorized reading of the inserted token identifier by rogue reading devices, reading of the incorrect token by a token reader, etc.

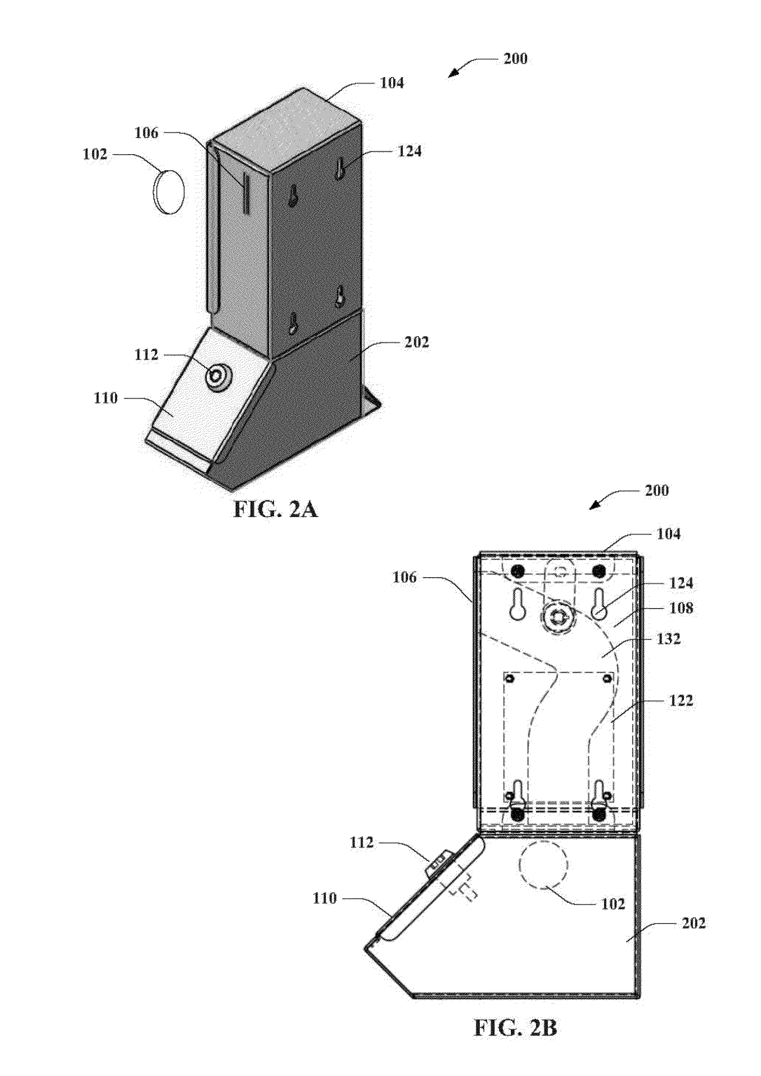

In another example, FIGS. 2A-2B illustrate token reader system 200 for receiving a token 102 and reading one or more identifiers of the token 102. A token 102 is received in slot 106 of a token reader 104, and passes through a reading region 108 via passageway 132 and near (or within) a portion of identifier reading component 122. Passageway 132, in this example, empties into a box 202 for storing tokens 102. Moreover, though shown as serpentine-shaped, it is to be appreciated that passageway 132 can have substantially any shape such that the token 102 can traverse at least a portion of the passageway 132 by gravity or other applied force. Box 202 can comprise a cover plate 110 and lock 112, as described, to allow access to box 202 for removing tokens 102. Moreover, token reader 104 can be mounted to a video-based gaming machine or a gaming station via mounting holes 124, for example, and can communicate directly or indirectly with the video-based gaming machine to provide an identifier of the token 102, associated account information, and/or the like, as described.

In one example, when the token 102 is in box 202, its identifier may no longer be read by identifier reading component 122, though such functionality is not required in this example. For example, this can be effectuated by constructing an exterior or interior portion of token reader 104, box 202, etc. from materials that interfere with transmission of the identifier from token 102, such as aluminum, as described above.

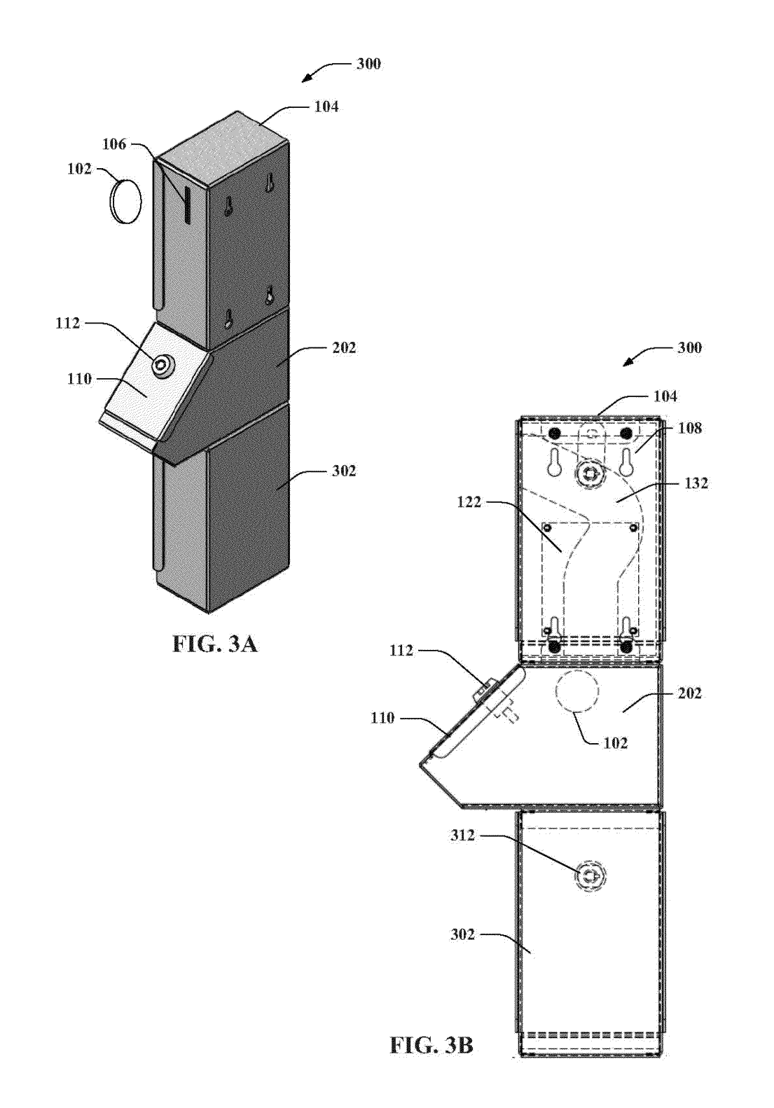

In yet another example, FIGS. 3A-3B illustrate token reader system 300 for receiving a token 102 and reading one or more identifiers of the token 102. A token 102 is received in slot 106 of a token reader 104, and passes through a reading region 108 via passageway 132 and near (or within) a portion of identifier reading component 122. Passageway 132, in this example, empties into a box 202 for storing tokens 102. Box 202 can comprise a cover plate 110 and lock 112, as described, to allow access to box 202 for removing tokens 102. Moreover, token reader 104 can be mounted to a video-based gaming machine or gaming station via mounting holes 124, for example, and can communicate directly or indirectly with the gaming machine to provide an identifier of the token 102, associated account information, and/or the like, as described. In addition, another storage box 302 is provided with a lock 312 for additionally storing tokens. In one example, box 202 can empty into box 302.

In one example, when the token 102 is in box 202 or 302, its identifier may no longer be read by identifier reading component 122, though such functionality is not required in this example. For example, this can be effectuated by constructing an exterior or interior portion of token reader 104, box 202, box 302, etc. from materials that interfere with transmission of the identifier from token 102.

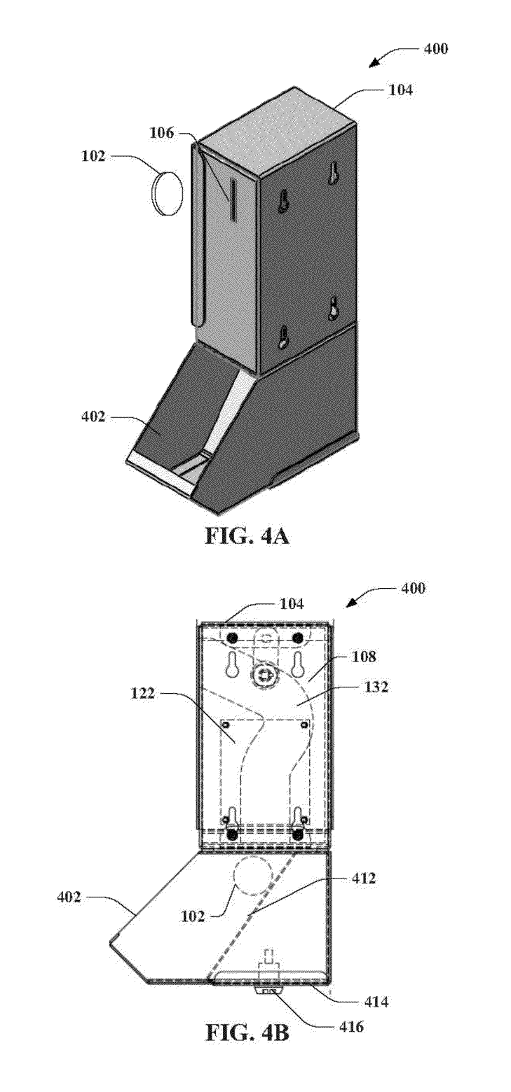

In another example, FIGS. 4A-4B illustrate token reader system 400 for receiving a token 102 and reading one or more identifiers of the token 102. A token 102 is received in slot 106 of a token reader 104, and passes through a reading region 108 via passageway 132 and near (or within) a portion of identifier reading component 122. Passageway 132, in this example, empties into an open return box 402 for storing tokens 102. Box 402 may include a ramp 412 for guiding the token 102 to the open portion of the box 402. Although not shown in the depicted example, box 402 may also include a cover plate 414 and lock 416 for storing tokens. Moreover, token reader 104 can be mounted to a video-based gaming machine or gaming station via mounting holes 124, for example, and can communicate directly or indirectly with the gaming machine to provide an identifier of the token 102, associated account information, and/or the like, as described. In one example, activation may be required for the video-based gaming system for each game by continually reinserting the token 102. This can cause acquisition of the associated account information and related crediting/debiting of corresponding credits for each game, in one example.

Moreover, in an example, when the token 102 is in box 402, its identifier may no longer be read by identifier reading component 122, though such functionality is not required in this example. For example, this can be effectuated by constructing an exterior or interior portion of token reader 104, box 402, etc. from materials that interfere with transmission of the identifier from token 102.

Moreover, in an example, token reader 104, or boxes 202, 302, etc. in the previously described example systems 100, 200, 300, and 400, may have a coin return feature by which the coin can be ejected from the token reader 104. In one example, this may cause further action as well, such as updating credits associated with the corresponding account based on detecting an event on the coin return feature or otherwise detecting that the coin is no longer present in reading region 108 or otherwise boxes 202, 302, 402, etc., as described. Alternatively, the coin ejection can occur based on an event from the gaming machine, such as detecting user logout of the gaming machine. Moreover, in an example, systems 100, 200, 300, and 400 may accept actual coins as well, and process credits according to types of coins received.

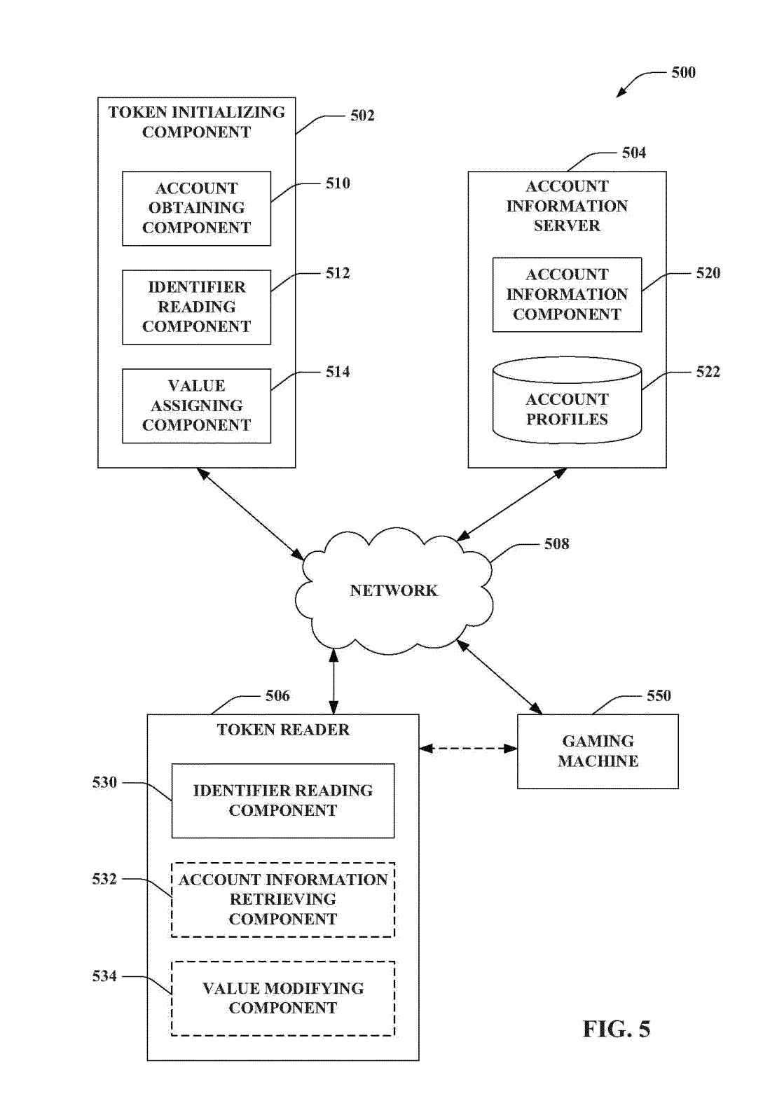

FIG. 5 illustrates an example system 500 for initializing and using a token to transfer value to/from an associated user account. System 500 includes a token initializing component 502 for associating a token with a user account, transferring value from the user account to the token or user account associated with the token, and/or the like, an account information server 504 for maintaining information of one or more user accounts, and a token reader 506 for identifying a token and retrieving account information related to a user account linked to the token. As shown, components 502, 504, and 506 can communicate over a network 508, though it is to be appreciated that a set of the components 502, 504, and/or 506 can be present in a single device or devices using other forms of electronic communication.

Network 508, for example, can be an internal local area network (LAN) or a collection of networks, and can include a collection of nodes communicatively coupled with one another via one or more components (e.g., switches, routers, bridges, gateways, etc.), which can include, or can include access to, an Internet, intranet, etc. In addition, in an example, components 502, 504, and 506, etc., can each be, or can collectively include, one or more servers purposed with performing at least a portion of the described functionalities. Thus, in one example, one or more of the components 502, 504, and 506 can be distributed among multiple servers within network 508 in a cloud computing environment.

Token initializing component 502 can include an account obtaining component 510 for receiving account information from an account information server or other data store, an identifier reading component 512 for determining an identifier of a token, and a value assigning component 514 for associating a value with the token or the account information. Account information server 504 can include an account information component 520 for obtaining, adding, removing, maintaining, or otherwise modifying account information from an account profiles data store 522. Token reader 506 can include an identifier reading component 530 for obtaining an identifier of a token, an optional account information retrieving component 532 for obtaining account information associated with the token identifier from an account information server or other data store, and an optional value modifying component 534 for retrieving, setting, or otherwise modifying a value associated with the token. Moreover, in an example, token reader 506 can communicate with a gaming machine 550 over a wired, wireless, etc. connection for providing a token identifier or related account information thereto.

According to an example, token initializing component 502 can associate a game activating token with a user account for activating a game or other machine, as described herein. For example, token initializing component 502 may be part of a self-service or managed point-of-sale (POS) terminal that can assign value to the token or a related account. In this example, where the token is to be associated with a user account, account obtaining component 510 may obtain account information from account information server 504 by sending a request thereto. Account information component 520 may obtain certain account information from account profiles data store 522 and return the information to token initializing component 502 as requested. In addition, identifier reading component 512 can obtain an identifier associated with the token; the identifier may be transmitted by the token (e.g., an RFID communicated by RFID electronics in the token). Thus, for example, identifier reading component 512 may comprise identifier reading electronics similar to those described for the token reader 104 to obtain an identifier of the token.

Value assigning component 514 can associate the token identifier with corresponding account information and/or can add value to the token or associated account information. For example, a user may provide a form of payment to the token initializing component 502, and the value assigning component 514 can assign a number of credits to the associated account. Value assigning component 514 can communicate modified account information to account information server 504. The modified account information can include the token identifier, account value added, account value debited, and/or the like, which account information component 520 can receive and accordingly update account profiles data store 522. In an example, the token identifier can be permanently, semi-permanently (e.g., for at least a period of time), or temporarily associated with account information.

In any case, the token can be initialized by associating the token with an account, in this example. Token reader 506 can then read an identifier of the token, as described previously, for associating a player's account information with a related device. For example, identifier reading component 530 can obtain the identifier transmitted by the token (e.g., an RFID), and account information retrieving component 532 can query the account information server 504 to obtain the associated account information based on the token identifier. Account information component 520 can obtain the token identifier and determine the related account information from account profiles data store 522. The retrieved information can include at least a value associated with the account linked to the token identifier, which can be provided to the token reader 506 or gaming machine 550. Token reader 506 can accordingly provide at least the value information (e.g., an amount of value or credits correlated to the user account or token) to a gaming machine 550 or other device with which the token reader 506 communicates. In one example, the token reader 506 can manage credits associated with the account, and crediting/debiting credits to/from the gaming machine 550. In any case, at some point, value modifying component 534 may store an updated number of credits to the account associated with the token identifier by providing such information to the account information server 504. In one example, this can be based at least in part on receiving a command from the gaming machine 550 or other device, detecting that the token is no longer present in token reader 506 (e.g., by the identifier reading component 530 no longer receiving the token identifier from the token, detecting a coin return button push), and/or the like.

In another example, token reader 506 can provide the token identifier to the gaming machine 550 or other device with which token reader 506 communicates for obtaining the related account information from account information server 504, such as the account value or other information. In this example, the gaming machine 550 or other device can also modify the account value (e.g., based on credits won or lost during game play). This can occur at each turn when credits are debited or credited for the turn, and/or upon completion of game play (e.g., as indicated by request from the user, ejection of the coin, and/or the like).

In yet another example, account information server 504 can store account information specific to the tokens in account profiles data store 522, which is not necessarily linked to other user account information. In this example, identifier reading component 512 can read the identifier of the token, and account obtaining component 510 can retrieve information associated with the token. Value assigning component 514 can modify a value of the token (e.g., based on payment received, funds distributed, etc.). Then, at token reader 506, identifier reading component 530 can obtain the token identifier, and account information retrieving component 532 can obtain information regarding the token from account information server 504, such as the value assigned to the token. In addition, value modifying component 534 can modify the value associated with the token, as described above, by communicating such (e.g., with the token identifier) to account information server 504. In addition, as similarly described above, identifier reading component 530 can obtain the identifier of the token, and token reader 506 can provide the identifier to a gaming machine 550 for performing the value retrieving and/or modification with the account information server 504.

In one specific example, the token initializing component 502 is coupled to or comprised within a POS terminal. A user can receive a token from an operator of the POS terminal, or from the POS terminal itself in an automated terminal configuration. In either case, the user can present payment for allocating credits to the token. As described, this can include allocating credits to the token and/or to an account of the user that is to be associated with the token. In these examples, identifier reading component 512 reads an identifier of a token—this can be a token obtained by an operator and placed on or near identifier reading component 512, a token automatically dispensed by the POS terminal that is dispensed near or in the path of identifier reading component 512, etc. Account obtaining component 510 can obtain user account information where the user logins in or is otherwise identified at the terminal, or account information regarding the token (e.g., where the token is not linked to the user account). In either case, account obtaining component 510 can communicate a request to the account information server 504 to retrieve such information, which can be received by account information component 520, processed by querying account profiles data store 522 with a related account or token identifier, and communicated to the token initializing component 502 by account information component 520. Value assigning component 514 can associate a value to the user account and/or token by communicating a value back to the account information server 504 for storing in account profile data store 522 with the account or token information. This association can include adding the value to a previously-stored value for the user account or token, initializing a new value, and/or the like. Account information component 520 can receive the value and accordingly update account profiles data store 522.

In this example, the POS can be communicatively coupled to the account information server 504 over a LAN within a gaming center, though it is to be appreciated that the devices can communicate using other media or technologies as well, as described. For example, a gaming center can include a plurality of gaming stations that can be interconnected over a LAN or other network. Once value is associated with the user account or token, the user can insert the token into a gaming machine that is coupled with token reader 506. For example, a gaming center can include a plurality of gaming machines each with respective token readers to allow activation of the gaming machines by inserting a token in the token reader 506. As described, the gaming machine can be coin-operated, such that inserting the coin-shaped token 102 facilitates activating the gaming machine. In any case, insertion of the token in a slot of the token reader 506 causes identifier reading component 530 to read an identifier of the token. As described, identifier reading component 530 disposed in a reading region of the token reader 506 can read the token identifier where the slot delivers the token past or near the identifier reading component 530. Moreover, as described, the token can remain in the token reader 506, in some examples, until it is removed by accessing the token reader by removal of a corresponding cover plate. In one example, a user may be required to login to the gaming machine 550 (e.g., where the token is not associated with the user account).

As described, token reader 506 can transmit the token identifier to the gaming machine 550, in one example, to allow gaming machine to retrieve the value associated therewith (and/or other information) from account information server 504. In another example, token reader 506 can manage account information associated with the token using account information retrieving component 532 and value modifying component 534, as described, and can communicate such information to, or receive updated information from, gaming machine 550. Value modifying component 534 or gaming machine 550 can update information associated with the token, such as the value remaining, by communicating such to account information server 504 after each game, after a gaming session (the termination of which can be indicated by the user on the gaming machine 550, on the token reader 506, etc.), and/or the like.

In another example, token reader 506 can communicate the identifier of the token to account information server 504, along with an identifier of the token reader 506 or associated gaming machine 550. In this example, account information component 520 can determine account information associated with the token from account profiles data store 522, and can activate the corresponding gaming machine 550 (e.g., based on the token reader 506 or gaming machine 550 identifier) with credits or other value associated with the account in the account information. Thus, in this example, the token reader 506 obtains the token identifier and uses the identifier to initiate communicate between the account information server 504 and gaming machine 550 to activate the game for the user associated with the token identifier. Updating of credits can occur directly between the gaming machine 550 and account information server 504, as described (e.g., once the game is terminated, during periodic events in the game or the gaming session, etc.).

In yet another example, the token can store value information, and the value assigning component 514 can assign a value to the token and transfer such information thereto for storing the value. In this example, identifier reading component 530 can read the identifier of the token and/or a value thereof to use in communicating with the gaming machine 550. Similarly, value modifying component 534 can communicate the value to the token for storage on the token following game play.

Moreover, in an example, the account information server 504 or gaming machine 550 may include the account information retrieving component 532, value modifying component 534, etc. to allow the described functionalities to additionally or alternatively perform these functions based on communications from the token reader 506.

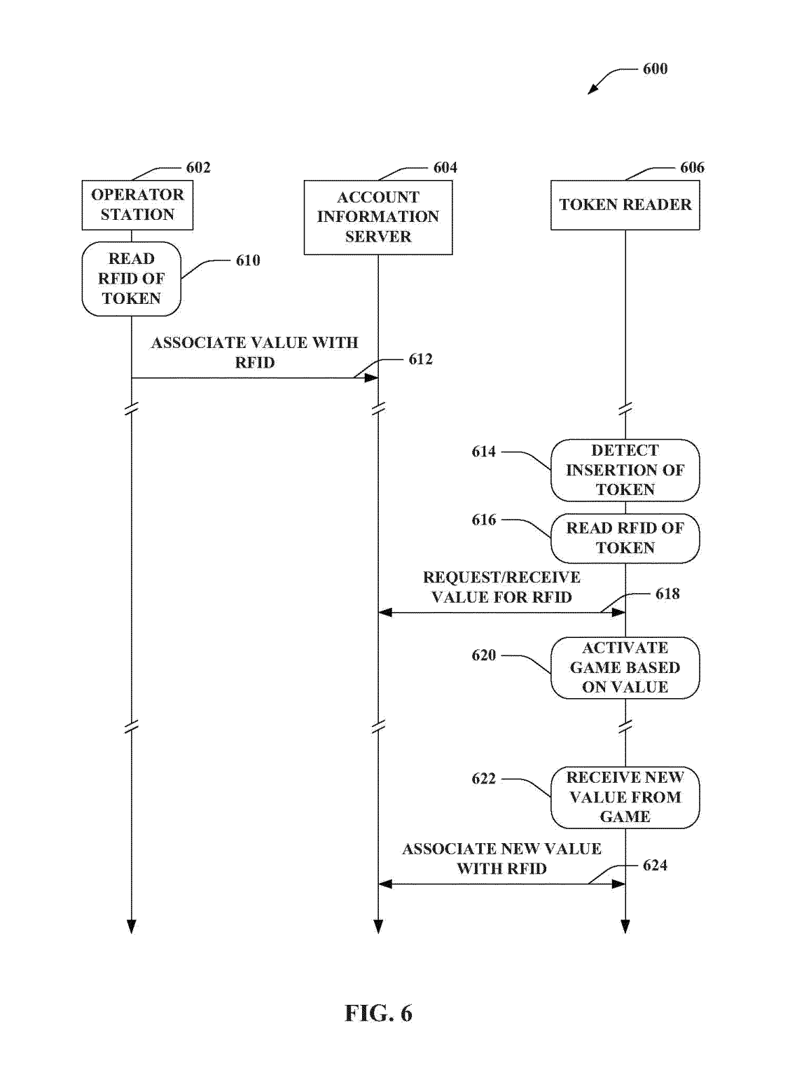

FIG. 6 illustrates an example system 600 for utilizing a token for activating a gaming machine. System 600 includes an operator station 602, an account information server 604, and a token reader 606. Operator station 602 can include a token initializing component 502, as described, account information server 604 can be similar to account information server 504, and token reader 606 can be similar to token readers 104 and 506, etc. Operator station 602 can read an RFID of a token at 610. As described, the operator station 602 can be a POS with an attached RFID reader for obtaining an RFID of a token in range. In addition, operator station 602 can associate a value with the RFID 612 by communicating value information and the RFID to account information server 604. For example, the value associated with the RFID can include credits related to money received at the operator station 602. In addition, the value can be associated with the RFID by associating the value with a user account or token account linked to the RFID at the account information server 604.

Token reader 606 can subsequently detect insertion of a token at 614, which can be the same token read by operator station 602 at 610. Token reader 606 can detect insertion of the token based at least in part on detecting triggering of an activation mechanism in a passageway traversed by the token, detecting the RFID by an RFID reader in the token reader 606, etc. At 616, token reader 606 can read the RFID of the token. The token reader 606 requests and receives a value for the RFID 618 from account information server 604. For example, as described, the account information server 604 can query for the value stored for the RFID or related user or token account to which the RFID is linked. Token reader 606 can activate a game based on the value. As described, the token reader 606 can be communicatively coupled to a gaming device, and can provide the value to the game for activation thereof based on the value. For example, the gaming device can initialize a game with a number of credits based on the value. Subsequently, the token reader 606 can receive a new value from the game, and can associate the new value with the RFID 624 by communicating the RFID and value to the account information server 604. This can occur upon termination of a game, termination of a session at the gaming machine, and/or the like. Moreover, when the session is terminated, the token can remain in the token reader 606, as described in one example, until retrieved by removing a cover plate from a reading region. Though, in other examples, the token can be ejected from the token reader 606 for retrieval by the user. Moreover, it is to be appreciated that the operator station 602 can distribute payment to a user based on value associated with the token, and accordingly update the token value at 612, in one example. In another example, when the session is terminated, the user can be presented with an online store catalog, which may otherwise have restricted access, to purchase certain items with any remaining credits.

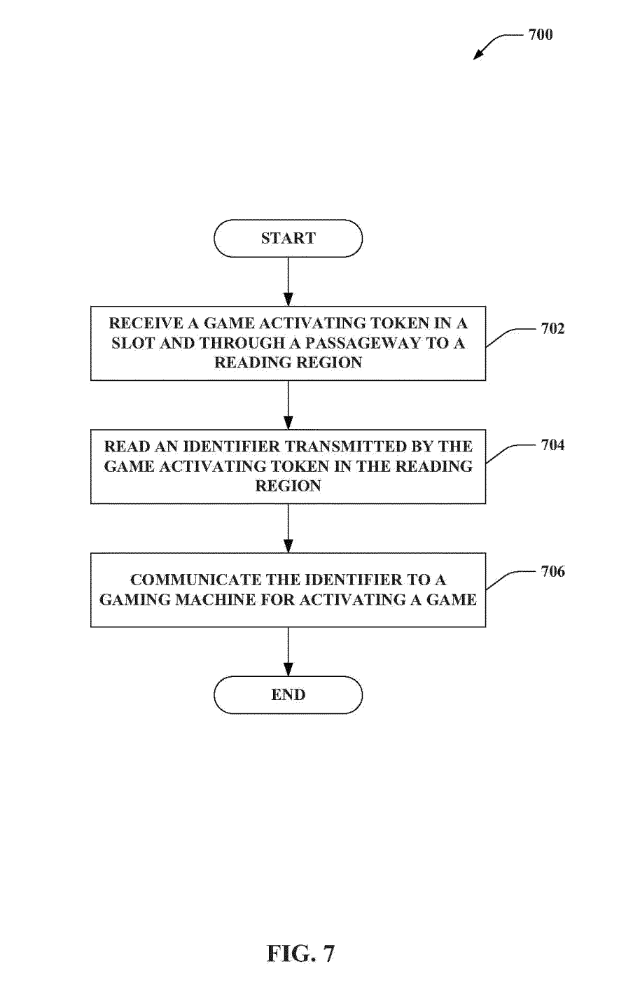

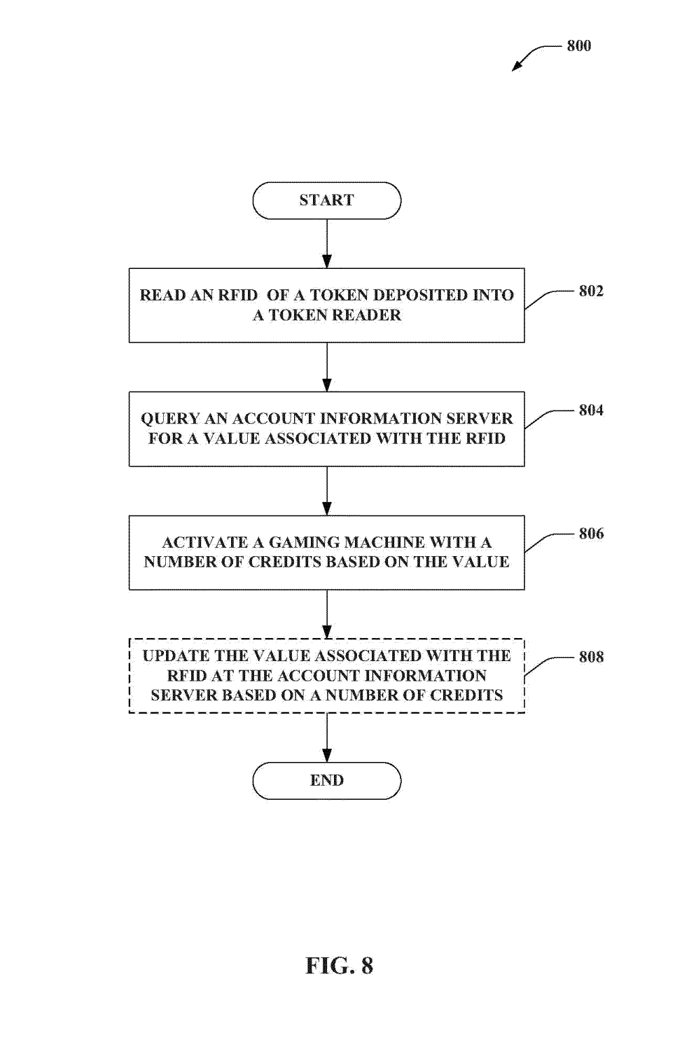

Referring to FIGS. 7-8, example methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 7 illustrates an example methodology 700 for activating a gaming machine based on receiving a game activating token. At 702, a game activating token is received in a slot and through a passageway to a reading region. For example, the passageway can be any sort of channel between the slot and the reading region. Moreover, as described, the reading region can be substantially any cavity, which can be enclosed, that houses identifier reading electronics (such as an RFID reader) to read the identifier transmitted by the token. In addition, the reading region can retain the token at least until a game ends, in one example.

At 704, an identifier transmitted by the game activating token can be read in the reading region. As described, this can be an RFID read by an RFID reader in the reading region. In addition, as described, the reading region can be composed of materials to prevent reading RFIDs outside of the reading region. At 706, the identifier can be communicated to a gaming machine for activating a game. In addition, for example, a value associated with the RFID can be communicated to the game where the value is determined from an account information server that stores data related to the RFIDs, associated values, associated user accounts, etc., as described.

FIG. 8 illustrates an example methodology 800 for activating a gaming machine based on receiving a game activating token. At 802, an RFID of a token deposited into a token reader is read. As described, the token reader is equipped with an RFID reader for reading RFIDs of tokens inserted into the token reader, and the tokens can be coin shaped tokens that drop down from a slot into a reading region where the RFID reader is disposed. At 804, an account information server can be queried for a value associated with the RFID. For example, the RFID is communicated to the account information server, and the account information server can transmit a value associated with the RFID and/or to a user account to which the RFID is linked, as described.

At 806, a gaming machine is activated with a number of credits based on the value. In one example, the number of credits are associated with the RFID. Game play can commence on the gaming machine using the number of credits. Optionally, at 808, the value associated with the RFID at the account information server can be updated based on a number of credits. For example, upon termination of the game or a gaming session on the gaming machine, the gaming machine can communicate the number of remaining credits to the account information server for association with the RFID.

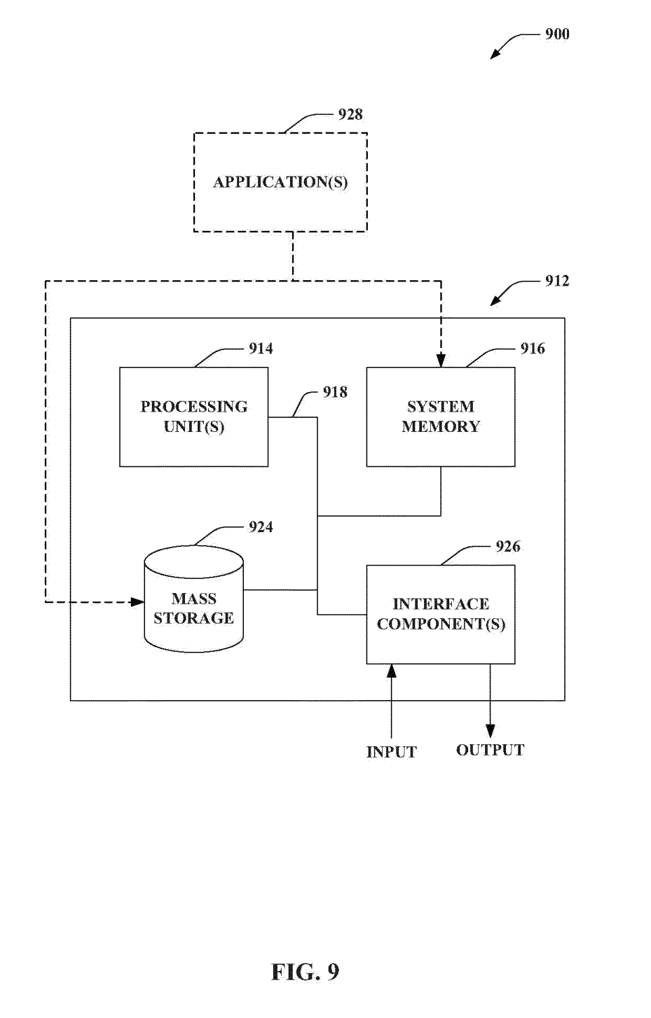

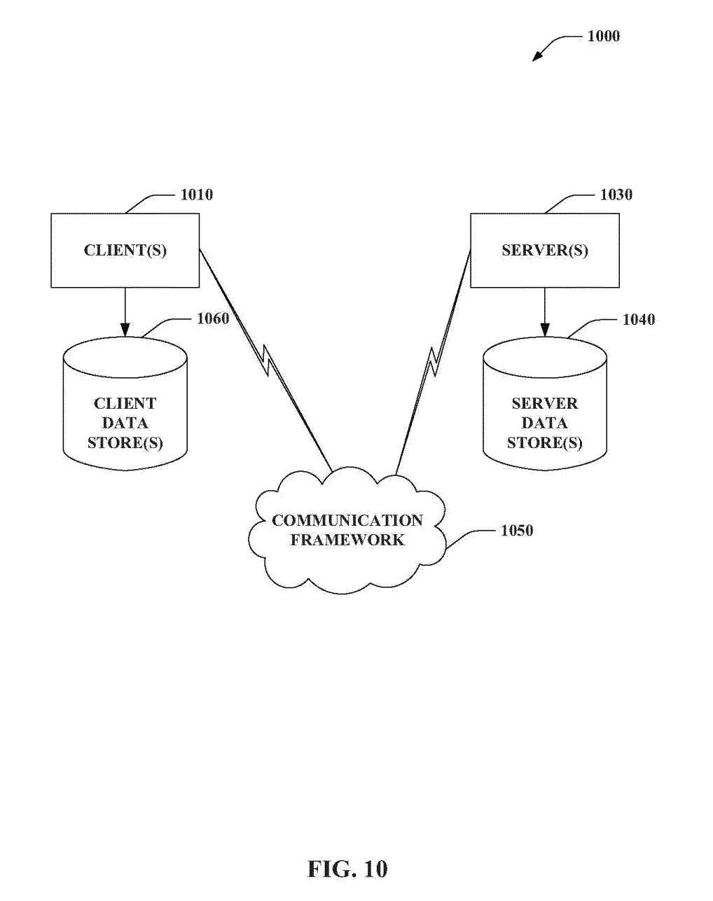

To provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., cathode ray tube (CRT), liquid crystal display (LCD), light emitting diode (LCD), plasma . . . ), speakers, printers and other computers, among other things.

According to an example, computer 912 can perform the functions described herein, such as retrieving account information associated with a token identifier, updating the account information, operating a game with a number of credits based on a value associated with the token identifier, etc., as described. In this example, the processing unit(s) 914 can comprise or receive instructions related to obtaining account information based on a token identifier, modifying the account information, initializing a game, etc., and/or other aspects described herein. It is to be appreciated that the system memory 916 can additionally or alternatively house such instructions and the processing unit(s) 914 can be utilized to process the instructions. Moreover, in some examples, mass storage 924 can be similar to account profiles data store 522.

FIG. 10 is a schematic block diagram of a sample-computing environment 1000 with which the subject innovation can interact. The environment 1000 includes one or more client(s) 1010. The client(s) 1010 can be hardware and/or software (e.g., threads, processes, computing devices). The environment 1000 also includes one or more server(s) 1030. Thus, environment 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The environment 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, one or more clients 1010 can be token readers or associated gaming machines that query server(s) 1030, which can be account information servers, via communication framework 1050 for token or account information associated with a token identifier. The one or more clients 1010 may receive account information from the server(s) 1030 over communication framework 1050, as described herein, and may use the account information to initializing a game with a number of credits.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

1. A system for receiving a game activating token, comprising:
a token reader, comprising:
a slot for receiving a game activating token having an associated identifier;
an identifier reading component disposed within a reading region of a token reader and configured to receive the associated identifier from the game activating token located in the reading region; and
an account information retrieving component for obtaining user account information associated with the associated identifier of the game activating token; and
a gaming machine for obtaining the associated identifier of the game activating token or the user account information from the token reader.

2. The system of claim 1, wherein the token reader further comprises a passageway disposed between the slot and the reading region for delivering the game activating token from a slot to the reading region.

3. The system of claim 2, wherein the identifier reading component is configured to receive the associated identifier from the game activating token when the game activating token is within the reading region.

4. The system of claim 1, wherein at least the reading region of the token reader comprises materials that block transmission of the associated identifier from the game activating token outside of the reading region.

5. The system of claim 4, wherein the materials include one or more aluminum walls.

6. The system of claim 1, wherein the identifier reading component comprises a radio frequency identifier (RFID) reader, and the associated identifier of the game activating token is an RFID transmitted by the game activating token.

7. (canceled)

8. (canceled)

9. The system of claim 1, wherein the token reader further comprises a value modifying component for modifying a value associated with the user account information based at least in part on output from the gaming machine.

10. The system of claim 9, wherein the value modifying component modifies the value based at least in part on the identifier reading component detecting that the associated identifier of the game activating token is no longer received.

11. A method for providing an identifier of a game activating token, comprising:
receiving the game activating token in a slot and through a passageway to a reading region;
reading an identifier transmitted by the game activating token in the reading region;
obtaining user account information associated with the identifier of the game activating token; and
communicating the identifier or the user account information to a gaming machine for activating a game.

12. The method of claim 11, further comprising blocking transmission of the identifier from the game activating token outside of the reading region.

13. The method of claim 11, wherein the game activating token comprises a radio frequency identifier (RFID) tag, and the reading comprises reading the RFID in the reading region.

14-15. (canceled)

16. The method of claim 11, wherein the account information comprises a value associated with the game activating token.

17. The method of claim 16, further comprising modifying the value based at least in part on output from the gaming machine.

18. The method of claim 17, wherein the modifying is based at least in part on detecting that the identifier of the game activating token is no longer received.

19. A system for activating a game, comprising:
a token reader for reading a radio frequency identifier (RFID) tag of a game activating token inserted into a slot of the token reader;
an account information server for obtaining or providing user account information associated with the game activating token based at least in part on the RFID tag, wherein the user account information includes a value of the user account associated with the game activating token; and
a gaming machine for receiving the value associated with the game activating token and initializing a game with a credit value based at least in part on the value associated with the game activating token.

20. The system of claim 19, further comprising an operator station for assigning the value to the game activating token, wherein the operator station comprises:
an RFID reader to determine the RFID of the game activating token; and
a point-of-sale (POS) terminal for accepting payment, and
wherein the operator station communicates the RFID and a value indicative of payment received at the POS terminal to the account information server for association with the game activating token.

21. The system of claim 1, wherein the token reader further comprising a box for storing tokens, and wherein the box receives the token after passing the reading region.

22. The method of claim 11, further comprising passing the token from the reading region to a box for storing tokens following reading of the identifier in the reading region.
